(19) United States
(12) Patent Application Publication
(10) Pub. No.: US 2010/0253201 A1
(43) Pub. Date: Oct. 7, 2010

(54) HIGH-INTENSITY DISCHARGE LAMP

(75) Inventors: Sven Schellinger, Aachen (DE); Albrecht Kraus, Kerkrade (NL); Lukas Kuepper, Aachen (DE); Klaus Schoeller, Nideggen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/743,008

(22) PCT Filed: Nov. 19, 2008
(86) PCT No.: PCT/IB08/54847

§ 371 Date: May 17, 2010

(30) Foreign Application Priority Data
Nov. 22, 2007 (EP) 07121263.3

(51) Int. Cl. H01J 61/30

(52) U.S. Cl. 313/113

(57) ABSTRACT

The invention relates to a high-intensity discharge lamp for a vehicle-light projector system, comprising a base (4) that carries an outer envelope (1) in which a burner (2) is arranged, the burner (2) comprising a discharge chamber (21) into which two electrodes (22, 23) project, the discharge chamber (21) being filled at least with an inert gas, a mixture of metal halides and a salt reservoir, the so-called “salt lake” (25). The outer envelope (1) has a coating (31) in strip form that screens off light and that extends, on the side of the outer envelope (1) adjacent the salt lake (25), for at least 40% of the length of the outer envelope (1) and whose width covers an angle of between 90° and 180° around the outer envelope (1). The invention also relates to a projector system for motor vehicle headlamps comprising at least one high-intensity discharge lamp of this kind.

The invention relates to a high-intensity discharge lamp for a vehicle-light projector system, comprising a base that carries an outer envelope in which a burner is arranged, the burner comprising a discharge chamber into which two electrodes project, the discharge chamber being filled at least with an inert gas, a mixture of metal halides and a salt reservoir, the so-called “salt lake”.

Filament lamps have long been used in the automotive field but as well as these what are increasingly being used as light sources for vehicle headlamps, due to the considerable improvement in light yield that they show over filament lamps, are high-intensity gas-discharge lamps. In known discharge lamps, a gas discharge that emits a very bright light is produced between two electrodes in a sealed discharge vessel.

For the purposes of the invention, headlamps for vehicles, such for example as ones that perform a low-beam light function, are all headlamps that produce a light/dark boundary, such for example as pure low-beam headlamps or combined high-beam/low-beam headlamps.

Headlamps are usually fitted with lamps that emit visible light of almost the same color in all directions in space, which means that what is then normally produced is a road space that is illuminated in a uniform color. It is known that, although bluish light is reflected better from obtruding objects in the road space, such as traffic signs for example, and is thus able to be perceived better, i.e. at an earlier point in time, by the driver of the vehicle that is illuminating the road space for this purpose, it does on the other hand dazzle traffic, and particularly oncoming traffic, in an undesirable way. To an increasing degree, high-intensity discharge lamps are being used in projector systems for motor vehicle front headlamps. Projector systems of this kind are formed in essence by a reflector and a lens, with the light source arranged between the reflector and the lens. Some of the light emitted by the light source is emitted directly onto the lens and some of it is emitted towards the reflector, from where it is reflected in turn either directly or indirectly onto the lens. The projector lens is so designed that the light from the headlamp meets the desired requirements.

A disadvantage of the known discharge lamps is that, when the lamp is installed in an approximately horizontal position, light is emitted both upwards and downwards. At least some of the light that is emitted downwards in this case is, in addition, refracted at the salt reservoir (the so-called “salt lake”) that is usually present in lamps of this type. The undirected, and in particular yellow, scattered light that arises when this happens is undesirable because some of it finds its way into the region where the oncoming traffic is situated and, when there, may cause the said oncoming traffic to be dazzled. Also, the contrast at the light/dark boundary is reduced by this scattered light. What is more, the known lamps require reflectors that are of a size such that the light, though emitted in all directions, is reflected onto the projector region of the lens. This produces reflectors that are of a considerable overall size.

It is to these problems that the invention aims to provide a remedy. An object underlying the invention is to provide a high-intensity gas-discharge lamp that, in relation to the total amount of light emitted, emits a smaller proportion of scattered light into the road space, that allows a greater contrast to be obtained at the light-dark boundary and that also enables the reflector to be made smaller in size. In accordance with the invention, this object is achieved by virtue of the features of claim 1.

The invention provides a high-intensity discharge lamp that, in relation to the total amount of light emitted, emits a smaller proportion of scattered light into the road space, that allows a greater contrast to be obtained at the light-dark boundary and that also enables the reflector to be made smaller in size. The coating in strip form that screens off light stops the scattered light coming from the salt lake from getting to the reflector. The strip can be configured to be of different shapes, such for example as that of an ellipse, a rectangle or an irregular geometrical figure. With this surprisingly simple solution, no visible light is emitted downwards. As a result, no undesirable scattered light is produced. The contrast at the light/dark boundary is thus increased because there is no scattered light present. Any dazzling of other road users by undirected, and in particular yellow, scattered light of this kind is avoided. With regard to the perceived color of the light coming from the headlamp, what is seen is light that appears brighter and in particular bluer or whiter.

In a further form of the invention, the coating in strip form is designed to be symmetrical to an imaginary plane that is defined by the axis of rotation of the outer envelope and an axis orthogonal thereto that extends through the salt lake. Uniform illumination is achieved by this means.

In one form of the invention, there is provided in addition at least one coating that screens off light and that extends around the outer envelope in a part-annular form. What is meant in what follows by the term “part-annular” is a region that does not entirely surround the lamp as it would if it were “annular” but does so only partly, i.e. the “annulus” may also not be a closed annulus. This enables the lamp to be adapted to a projector system. Those regions of the lamp whose emitted light is directed outside the reflecting regions of the reflector are screened off, which is a further means of preventing the possibility of scattered light.

In a further form of the invention, the boundary of an annular coating in the direction leading towards the base is defined substantially by the free end of that electrode which is remote from the base. The annular coating preferably screens the outer envelope off completely in the direction leading away from the base. This is an effective way of preventing scattered light from being emitted.

In a further form of the invention, an annular coating is arranged between the base and the free end of that electrode which is adjacent the base. The distance from the annular coating to the discharge chamber is preferably equal to or greater than a tenth of the length of the outer envelope. What is achieved in this way is that the light source is screened off from non-reflecting surfaces in the region of the base. Advantageously, the annular coating completely screens off the body of the outer envelope in the area where the said body is close to the base.

In a further form of the invention, at least part of at least one coating is in the form of a filter. This enables yellow parts of the light to be filtered out.

In one form of the invention, at least part of at least one coating is in the form of a reflective surface. This enables the light source to be partly screened off while at the same time the incident light from it is reflected into desired regions.

In an advantageous form of the invention, at least part of at least one coating is of a two-layered form, with a black layer being applied to a blue reflective layer in the direction leading away from the burner. By this means, the yellow light from the salt lake is reflected in blue by the blue reflective layer; yellow light passes through the layer and is then absorbed by the black layer situated beneath it. What is achieved in this way is directed illumination with no loss of light yield.

The invention also relates to a projector system for motor vehicle headlamps that, in relation to the total amount of light emitted, emits a smaller proportion of scattered light into the road space, that allows a greater contrast to be obtained at the light-dark boundary and that also enables the reflector to be made smaller in size. In accordance with the invention, this object is achieved by virtue of the features of claim 12. By selectively masking the outer envelope, it is possible to configure the region on which light is incident, as a result of which it is possible for the reflector of the projector system to be designed to take up a considerably smaller amount of overall space. This is achieved by, in particular, the reduction in the angle of emission of the light source.

Other forms and variants of the invention are specified in the rest of the dependent claims. An embodiment of the invention is shown in the drawings and is described in detail below. In the drawings:

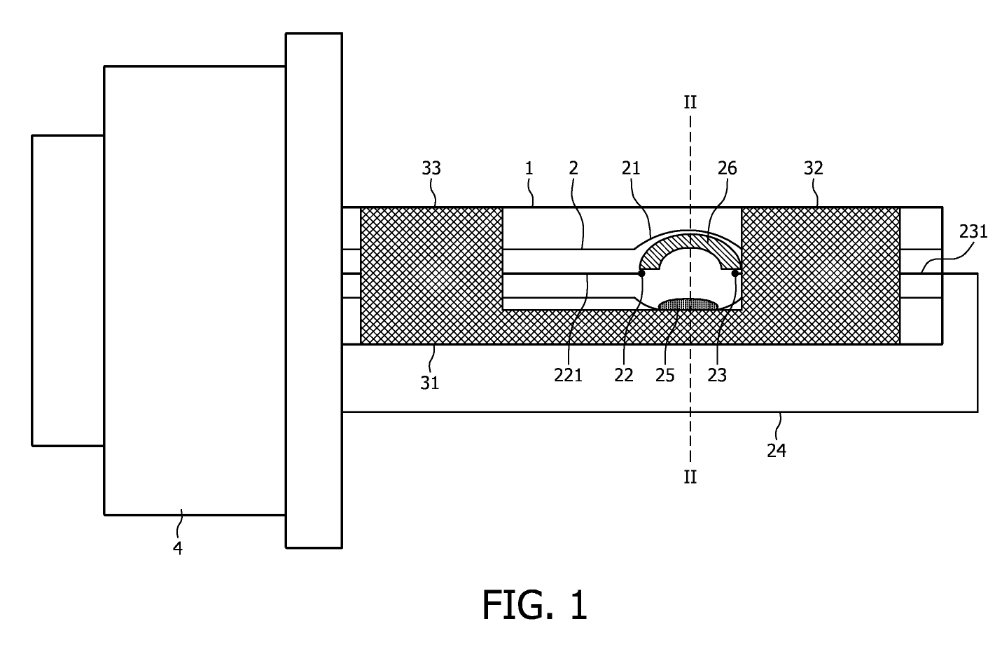

FIG. 1 is a schematic view from the side of a high-intensity discharge lamp.

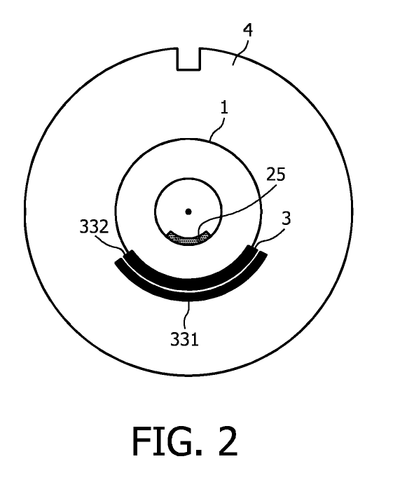

FIG. 2 is a cross-section on line II-II in FIG. 1.

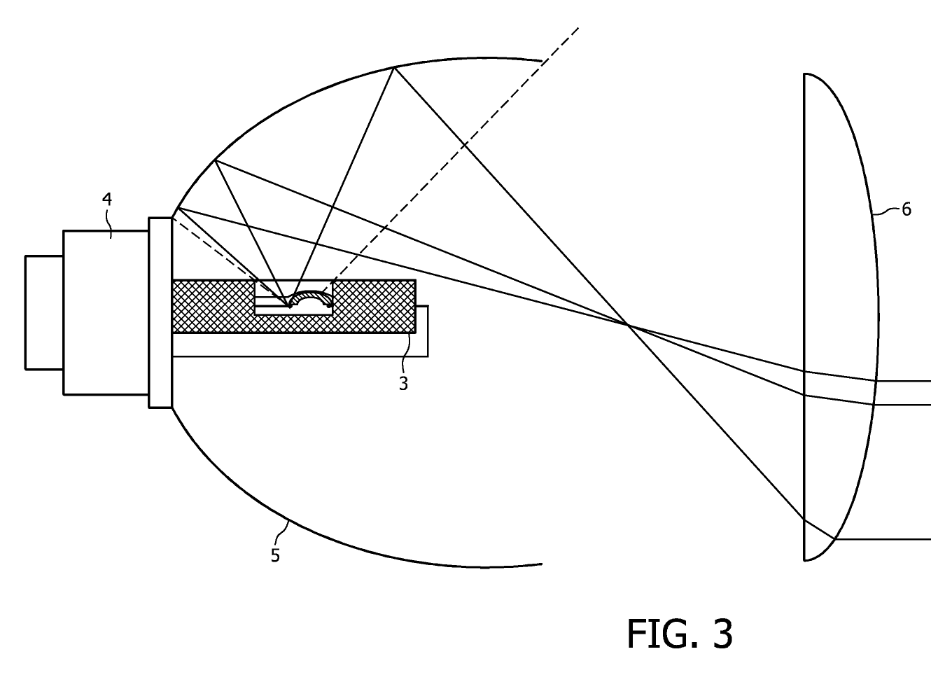

FIG. 3 is a schematic view of a projector system having a high-intensity discharge lamp according to the invention, showing the paths followed by rays.

The discharge lamp that is selected as an embodiment comprises an outer envelope 1 in which a burner 2 is arranged and that is connected to a base 4.

The high-intensity discharge lamp is shown in an approximately horizontal installed position, a “salt lake” 25 being situated in the bottom region of the discharge chamber 21. The lamp has a burner 2, composed of quartz glass, that transmits light and has vacuum-tight seals. The burner 2 encloses a discharge chamber 21. The discharge chamber 21 is filled with an ionizing mixture of gases that comprises at least one inert gas, and in particular xenon, and a mixture of metal halides. Arranged opposite one another in the usual way in the discharge chamber 21 are two electrodes 22, 23. The clear distance between the two electrodes 22, 23 forms the discharge path, in the center of which the center of the discharge chamber 21 is also situated.

The electrode 22 is connected in the usual way to a current conductor 221; the electrode 23 is connected to a current conductor 231 that is connected in turn to the return pole 24 that is run to the base 4, outside the outer envelope 1, approximately parallel to the longitudinal axis of the lamp.

Arranged on the surface of the exterior of the outer envelope 1, on the side thereof adjacent the salt lake 25, is a coating 31 in strip form. The coating 31 is formed by a blue reflective layer 332, to which a black layer 331 is applied. The coating 31 in strip form may in particular be formed by a filter that is an absorbent or reflective coating. Good results have been achieved with a blue filter to which a mirror-like or reflective layer is applied.

The coating 31 in strip form is designed to be symmetrical to an imaginary plane that is defined by the axis of rotation of the outer envelope 1 and an axis orthogonal thereto that extends through the “salt lake” 25. At its two ends, the coating 31 in strip form merges with respective layers 32, 33 of an annular form. In the direction leading towards the base 4, the boundary of the annular layer 32 is defined substantially by the free end of that electrode 23 which is remote from the base and the said annular layer 32 screens off the major proportion of the outer envelope 1 in the direction leading away from the base 4. The annular coating 33 is arranged between the base 4 and the free end of that electrode 22 which is adjacent the base. The distance from the annular coating 33 to the discharge chamber 21 is approximately an eighth of the length of the outer envelope 1 in this case.

The light that is emitted by the arc that is generated between the electrodes 22, 23 is confined to the reflective areas of the reflector 5 of a projector system by the annular layers 32, 33. The coating 31 in strip form screens off the emitted light in the downward direction, with the blue parts of the light being reflected, thus enabling a high light yield with only a low level of lost power to be achieved due to the directed white light.

What is crucial to the light yield of a projector system is the proportion of light that is incident on the reflector. The production of directed white light by the selective screening-off and reflection/filtering of the light emitted by the arc 26 makes it possible for the size of the reflector to be reduced, which in turn makes it possible for the overall space occupied by the projector system to be made smaller. As the same time, scattered light and the yellow light produced by the salt lake 25 are eliminated.

1-12. (canceled)

13. A high-intensity discharge lamp for a vehicle-light projector system, the lamp comprising:
a base;
an outer envelope connectable to the base and defining a discharge chamber;
two electrodes disposed within the discharge chamber for creating an arc discharge to emit light;
a reflective strip at least partly surrounding the discharge chamber; and
a salt reservoir arranged within the discharge chamber on a path between the electrodes and the reflective strip such that the light refracted by the salt reservoir is at least partially reflected by the reflective strip.

14. The lamp of claim 13, wherein the reflective strip is a coating of a part of the outer envelope adjacent the salt reservoir.

15. The lamp of claim 13, wherein a length of the reflective strip is at least 40% of a length of the outer envelope, and a width of the reflective strip covers an angle of between 90° and 180° around the outer envelope.

16. The lamp of claim 13, wherein the discharge chamber is filled at least with an inert gas, and a mixture of metal halides.

17. The lamp of claim 13, wherein the reflective strip is symmetrical relative to a plane defined by an axis of rotation of the outer envelope and an axis orthogonal thereto and extending through the salt reservoir.

18. The lamp of claim 13, further comprising:
at least one reflecting coating having at least partly-annular form, the reflecting coating arranged at least around a part of the outer envelope opposite to the base and configured to reflect the light emitted in the direction leading away from the base.

19. The lamp of claim 13, further comprising:
at least one reflecting coating having at least partly-annular form, the reflecting coating arranged between the base and a free end of one of the two electrodes adjacent to the base.

20. The lamp of claim 19, wherein a distance from the reflecting coating to the discharge chamber is equal to or greater than a tenth of a length of the outer envelope.

21. The lamp of claim 13, wherein the reflective strip comprises a filter.

22. The lamp of claim 13, wherein the reflective strip is connected to two reflecting coatings having at least partly-annular form, wherein the reflective strip and the two reflecting coatings are configured to reflect the light back into the discharge chamber such that the light is emitted only from one side of the outer envelope.
